(19) United States
(12) Patent Application Publication
(10) Pub. No.: US 2005/0147718 A1
(43) Pub. Date: Jul. 7, 2005

(54) Food container barrier

(76) Inventors: David Watzke, Placentia, CA (US); Maureen Watzke, Placentia, CA (US)

Correspondence Address: GRAY LAW FIRM, Suite 233, 4401 N. Atlantic Ave., Long Beach, CA, 90807, US

(21) Appl. No.: 11/072,085

(22) Filed: Mar. 3, 2005

Related U.S. Application Data
(63) Continuation-in-part of application No. 10/723,575, filed on Nov. 26, 2003.
Application No. 10/723,575 is a continuation-in-part of application No. 10/412,008, filed on Apr. 11, 2003.

(51) Int. Cl. A23B 4/00

(52) U.S. Cl. 426/112

(57) ABSTRACT

The present invention is an improved food container barrier. In particular, the present invention is directed to a food container barrier for dividing a food container into at least two chambers. A preferred embodiment of the food container barrier comprises a circular tabbed plane with two tabs, where the tabs are pivotal along a circumferential crease in the plane and configured to support the plane within a food container when bent. The barrier thus creates two separate chambers within the food container. The barrier has at least one passage through the thickness of the plane positioned on the perimeter of the plane configured to exclude passage of selected food items. The barrier is preferably bowed convex.

The present application is a continuation-in-part application of U.S. patent application Ser. No. 10/723,575 filed on Nov. 26, 2003, which is a continuation-in-part of U.S. patent application Ser. No. 10/412,008 filed on Apr. 11, 2003. Both U.S. patent application Ser. Nos. 10/723,575 and 10/412,008 are incorporated herein by reference in their entirety.

### TECHNICAL FIELD

The present invention is an improved food container barrier. In particular, the present invention is directed to a food container barrier for dividing a food container into at least two chambers.

### BACKGROUND ART

In the food service industry, it has long been desirable to delay mixing certain food ingredients together until just prior to consumption. The service of fresh green salad is one such example. Dressing added to the salad just prior to its consumption advantageously preserves the freshness, crispness, and distinctive taste of the greens, croutons, and other rough ingredients that are susceptible to dressing absorption. All too frequently, dressing is applied to roughage too early resulting in a drenched, wilted, and limp concoction that is rejected by consumers as inferior. When ordering a Caesar salad, for instance, it is traditional for the salad dressing to be prepared tableside and then rapidly tossed with the other ingredients such as romaine lettuce and croutons for immediate transfer onto a diner's plate for enjoyment. Tableside preparation, however, is costly and time consuming and not particularly well suited to the fast-food or high volume food service industries.

Consumers that make salad at home for later consumption face a similar dilemma regarding the preparation of, for example, salad ingredients and the effects of adding dressing prematurely. Additionally, it is desirable for portability to avoid transporting, for example, salad dressings and/or seasonings in separate containers from salad roughage when the salad or other food combination is part of a picnic or box lunch. Moreover, if existing food containers can be modified for this purpose, consumers and members of the food service can avoid purchasing additional containers.

Therefore, it is desirable for an improved food container barrier that can modify an existing food container to reduce or eliminate the need to store, in separate containers, large ingredients such as salad roughage apart from smaller or liquid ingredients, such as salad dressing and/or seasoning, until mixing them together is desired. Such an improved food container barrier can also he used to keep fruit from being over immersed in its own juices and slow the deterioration of the quality, shelf life and flavor of the fruit.

### SUMMARY OF THE INVENTION

The present invention is an improved food container barrier. In particular, the present invention is directed to a food container barrier for dividing a food container into at least two chambers. A preferred embodiment of the food container barrier comprises a circular tabbed plane with two tabs, where the tabs are pivotal along a circumferential crease in the plane and configured to support the plane within a food container when bent. The barrier thus creates two separate chambers within the food container. The barrier has at least one passage through the thickness of the plane positioned on the perimeter of the plane configured to exclude passage of selected food items. The barrier is preferably bowed convex.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings.

FIG. 1 is a top view of a preferred embodiment;

FIG. 2 is a perspective view of the embodiment in FIG. 1;

FIG. 3 is a view of the embodiment of FIG. 1 inserted into a container;

FIG. 4 is an alternative preferred embodiment;

FIG. 5 is a view of the embodiment of FIG. 4 inserted into a container to separate food items;

FIG. 6 is a top view of another preferred embodiment;

FIG. 7 is a perspective view of the embodiment of FIG. 6;

FIG. 8 is a view of the embodiment of FIG. 6 inserted into a container;

FIG. 9 is a cross-sectional view of the embodiment from FIG. 6 inserted into another container; and,

FIG. 10 is a cross-sectional view of the embodiment of FIG. 6 inserted into a container with tabs folded above the plane.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein specifically to provide an improved food container barrier.

Referring now to FIG. 1, a top view of a preferred embodiment of the invention 10 is shown. In the embodiment shown in FIG. 1, a circular plane 20 comprises multiple holes or passages 25 passing through the thickness of the plane 20. The passages 25 shown in FIG. 1 are placed circumferentially on the surface of the plane 25. Alternately, the holes 25 can be placed in a variety of configurations on the plane 20 including but not limited to randomly or in a grid pattern. The holes 25 are configured to exclude passage of selected food items through the passages 25. For example, a preferred embodiment of the invention would have passages 25 that are small enough to prevent green salad components such as pieces of lettuce, tomato and cucumber from passing through the holes 25 while being large enough to allow a flow of, e.g., salad dressing or seasonings through the plane 20.

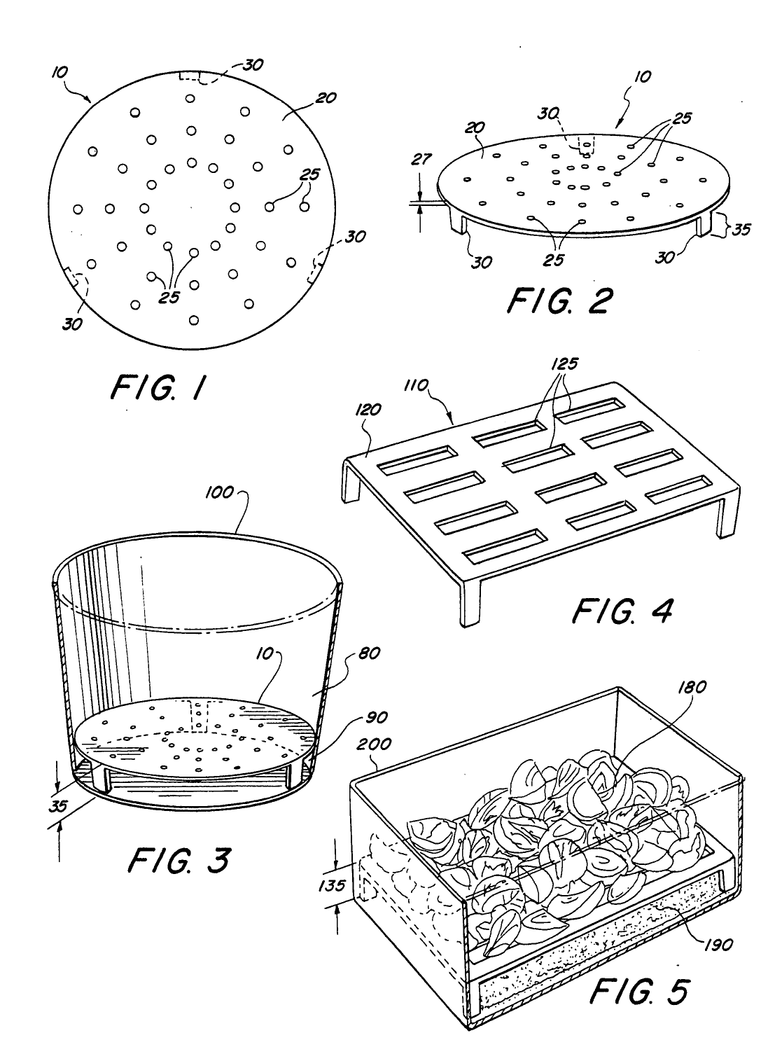

Referring now to FIG. 2, a perspective view of the preferred embodiment in FIG. 1 is shown. As shown, the plane 20 preferably has a thickness 27 through which holes 25 pass. The preferred thickness 27 can vary based on the weight of the product to be supported and surface area of the container. Further, as shown in FIG. 2, three legs 30 extend downward from the plane 20. The legs 30 each preferably have a height 35 no higher than 50% of the total height of the container in which the barrier 10 is to be placed. When resting on the legs 30 within a container 100, the preferred embodiment of the invention 10 creates two separate chambers 80 and 90 within the container 100. The secondary chamber 90 preferably contains relatively smaller food items such as salad dressing, seasoning, or juices and the primary chamber 90 preferably contains large food items such as lettuce, tomato, cucumber or pieces of fruit. Depending on the height 35, the secondary chamber 90 can contain different volumes of the smaller food items described above. FIG. 3 is a perspective view of the preferred embodiment of FIG. 1 inserted into a food container 100 thereby creating the primary 80 and secondary 90 chambers. When the container 100 is inverted, the smaller food items can passes through the holes 25 of the invention 10 from the secondary chamber 90 to the primary chamber 80 to mix with the relatively larger food items.

Referring now to FIG. 4, a perspective view of another alternative embodiment of the invention is shown. The invention can be manufactured to accommodate various shapes of food containers. FIG. 4 shows a rectangular embodiment of the invention 110. Here, the invention 110 comprises a rectangular shaped plane 120 of a predetermined thickness 127 with multiple passages 125 through the thickness of the plane 120. The rectangular plane shown stands on four legs 130, each preferably with a height 135. When inserted into a rectangular container 200, the embodiment, as shown in FIG. 5, create a primary 180 and secondary 190 chamber. FIG. 5 shows the relatively larger food items resting on the plane 120 while the relatively smaller food items (dressing is shown) sit below in the secondary chamber 190.

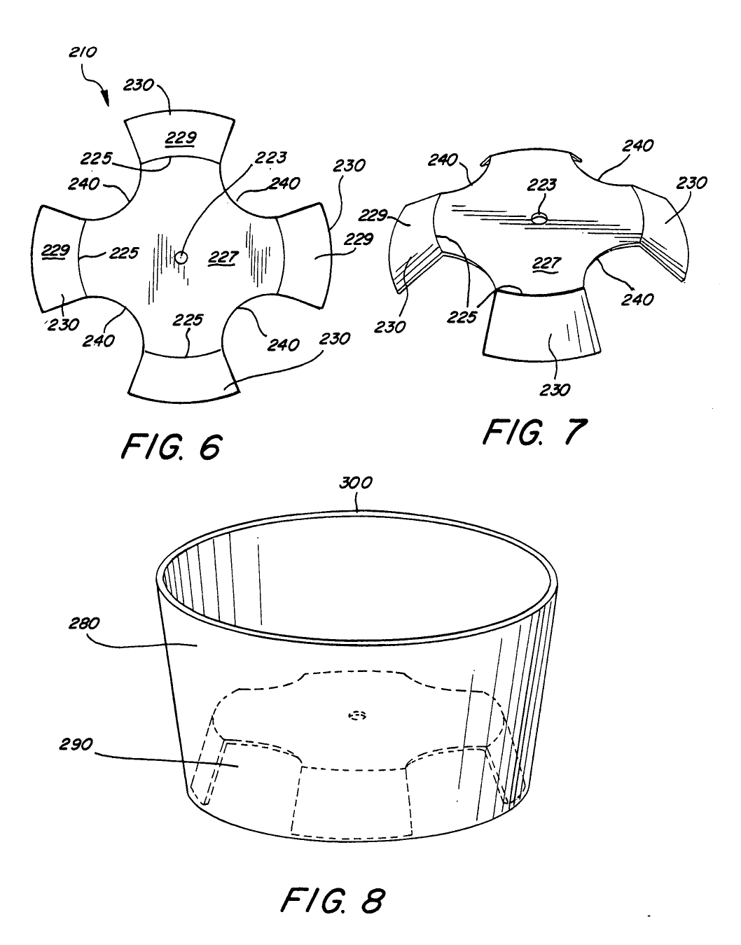

FIG. 6 is a top view of an alternative preferred embodiment of the invention 210. As shown in FIG. 6, the embodiment 210 comprises a circular plane 220 with a crease 225 positioned circumferentially on the plane 220. The crease 225 creates interior 227 and exterior 229 surfaces on the plane 220. The plane 220 shown has four tabs 230. Each tab 230 when folded along the crease 225, either above or below the plane 220 creates a support for the plane 220. As shown in FIG. 7, the tabs 230 are folded along the crease 225 below the plane 220. The plane 220 further comprises indentations 240 along its perimeter bounded by the tabs 230. The indentations 240 preferably extend beyond the crease 225 into the interior 227 of the plane 220. As shown in FIGS. 6 and 7, the plane 220 preferably has a passage 223 at its center. Alternatively, passages can be placed throughout the surface of the plane 220 such as those shown in FIG. 1. Also passages can be placed on the surface of one or more tabs 230.

Referring now to FIG. 8, the embodiment 210 is shown inserted into a food container 300. By folding the tabs 230 along the crease 225 below the plane 220, the tabs 230 support the plane 220 above the bottom of the container 300. Thus, the container 300 is divided into a primary chamber 280, preferably for relatively large food items, and a secondary chamber 290, preferably for relatively smaller food items. Moreover, the tabs 230 and indentations 240, along with the hole 223, preferably create passageways between the primary 280 and secondary 290 chambers.

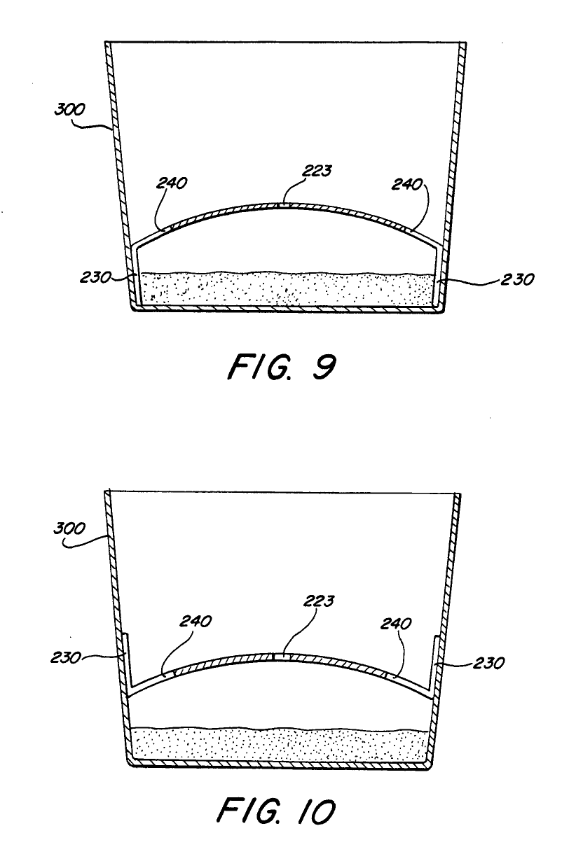

FIG. 9 is a cross-sectional view of the embodiment shown in FIGS. 6, 7 and 8. As shown, the plane 220 has a convex surface. This allows liquid to drain off the barrier 10. This is useful after the container has been inverted and then returned to its standing position or when juice drips from fruit in the primary chamber 280. The convex surface 220 also keeps passageways further from liquids and/or other items in the secondary chamber 290.

Referring now to FIG. 10, a cross-sectional view of the embodiment shown in FIG. 6 and 7 is shown. However, the tabs 230 have been bent along the crease 225 above the plane 220. When configured as such in a properly sized container 300, the tabs 230 support the plane 220 above the bottom of the container 300 with a friction fit along the surface of the container 300.

The barrier 10 is preferably made of food grade plastic such as polyvinyl chloride (“PVC”), polyethylene terephthalate (“PET”), polystyrene, polyethylene, or polypropylene.

Thus, an improved food container barrier is described above that can modify an existing container such that the container has at least two chambers. In each of the above embodiments, the different positions and structures of the present invention are described separately in each of the embodiments. However, it is the full intention of the inventor of the present invention that the separate aspects of each embodiment described herein may be combined with the other embodiments described herein. Those skilled in the art will appreciate that adaptations and modifications of the just-described preferred embodiment can be configured without departing from the scope and spirit of the invention. For example, the embodiment of FIGS. 6-10 can have a rectangular shape such as the embodiment of FIGS. 4 and 5. Therefore, it is to be understood that, within the scope of the appended claims, the invention may be practiced other than as specifically described herein.

1. A food container barrier comprising:
a plane having a thickness and at least one passage through the thickness of the plane, said at least one passage configured to exclude passage of selected food items through the passage; and,
at least one support structure extending from the plane and where said at least one support structure is configured to support the plane within a food container and thereby create at least two separate chambers within said food container.

2. The food container barrier of claim 1 where the at least one support structure is a plurality of legs extending below the plane such that the plurality of legs can support the plane in said food container.

3. The food container barrier of claim 1 where the at least one passage is configured to selectively exclude passage of relatively large food items and to allow passage of relatively small food ingredients.

4. The food container barrier of claim 1 where the at least one support structure is at least one hanger extending above the plane such that the at least one hanger can be attached to a rim of the food container to support the plane and create at least two separate chambers within said food container.

5. The food container barrier of claim 1 where the at least one passage is a grid.

6. A food container barrier comprising:
a tabbed plane having at least one tab, where said at least one tab is pivotal along a crease in the plane and configured to support the plane within a food container when bent along the crease;
where the barrier creates at least two separate chambers within said food container.

7. The food container barrier of claim 6 where the plane further comprises a thickness and at least one passage through the thickness of the plane, said at least one passage configured to exclude passage of selected food items through the passage.

8. The food container barrier of claim 7 where the at least one passage is located on the perimeter of the plane and bounded by the plane and the food container.

9. The food container barrier of claim 6 where the plane is a disk and the crease is circumferentially located in the plane.

10. The food container barrier of claim 6 where the plane is convex.

11. The food container of claim 7 where the at least one passageway is located at least portionally on the at least one tab.
